(19) United States
(12) Patent Application Publication
(10) Pub. No.: US 2007/0297741 A1
(43) Pub. Date: Dec. 27, 2007

(54) Method for Determining Clinical and/or Chemical Parameters in a Medium and Device for Carrying Out Said Method

(76) Inventor: Patrick Linder, Mandach (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/589,119

(22) PCT Filed: Feb. 9, 2005
(86) PCT No.: PCT/CH05/00071

§ 371 Date: May 4, 2007

(30) Foreign Application Priority Data
Feb. 11, 2004 (CH) PCT CH2004 00080
Feb. 11, 2004 (CH) CH2004 00079
Sep. 2, 2004 (EP) 04020810.0

(51) Int. Cl. G02B 6/10

(52) U.S. Cl. 385/130

(57) ABSTRACT

A method for determining clinical and/or chemical parameters (S1) in a medium (10), utilizing a laser unit, for emitting coherent light waves (6) and a phototransistor unit, for receiving light waves (8). At least some of the emitted light waves (6) are transferred to the medium (10) and the phototransistor unit waves (8) measures at least some of the light waves (8) that are reflected in the medium (10), the parameters (S1) being determined as a result of the characteristics of the emitted and received light waves (6; 8). The fact that light waves (6) are emitted into the medium (10) by a laser unit (2) and that the light waves (8) that are reflected in the medium (10) are measured by a phototransistor (4) enables the parameters (S1) that occur in the target area of the laser beam to be determined advantageously in a processing and control unit.

### RELATED APPLICATION

This application is a U.S. national phase application under 35 U.S.C. §371 of International Application No. PCT/CH2005/000071 filed Feb. 9, 2005, which claims priority of International Application No. PCT/CH2004/00080 filed Feb. 11, 2004.

### TECHNICAL FIELD

The present invention relates to a method for determining clinical and/or chemical parameters in a medium and an apparatus for carrying out the method.

### BACKGROUND

In order that substances or a concentration of a substance can be accurately determined in the living body, it is necessary to take samples from the body, which samples are then treated by special analytical methods with the use of suitable reagents. Sampling, for example the drawing of blood and the consumption of reagents, is perceived as a disadvantage in these known methods. A noninvasive method for determining the glucose content would be of great advantage particularly in the case of diabetics, who must test the glucose content in the blood many times in the course of a day.

For this reason, a plurality of methods and apparatuses for noninvasive determination of the glucose content in the blood have already been proposed. Reference is made to the following publications as being representative: WO 95/04 496 and WO 01/26 538. It has been found, however, that the known methods are not suitable for obtaining accurate measurement results. For diabetics in particular, the measurement results are so inaccurate that they cannot be employed for monitoring or adjusting the blood sugar level. To be sure, the known methods can be used for a rudimentary indication of the instantaneous blood sugar content, but conventional monitoring measurements, that is, re-sampling, must be performed in order to determine the requisite quantity of medication that is needed for accurately adjusting the blood sugar level.

### SUMMARY OF INVENTION

It is therefore a goal of the present invention to identify a method and an apparatus for determining clinical and/or chemical parameters in a medium with high accuracy.

This goal is achieved with the method of the for determining clinical and/or chemical parameters in a medium utilizing means for transmitting coherent light waves and means for receiving light waves, the method comprising: delivering at least a part of the transmitted light waves into the medium, measuring with the means for receiving light waves at least a part of the light waves reflected in the medium, determining the parameters on the basis of the properties of the transmitted and received light waves. Advantageous developments of the invention and an apparatus for carrying out the method are described below.

The invention has the following advantages: By delivering light waves into the medium with a laser unit and measuring the light waves reflected in the medium with a phototransistor unit, the parameters prevailing in the target region of the laser beam can be determined in a processing or monitoring unit. To this end, in a further embodiment of the invention, the frequency or wavelength of the waves generated by the laser unit is tuned in accordance with characteristic properties of the parameters to be determined, and the parameters are determined with reference to the signals measured with the photodiode unit. It has been found that extremely accurate results can be obtained with the method according to the invention, in particular for parameters such as cholesterol.

Furthermore, extremely accurate results can be obtained in the case of parameters such as glucose with the method utilizing means for transmitting microwaves and means for receiving microwaves, and including the steps of delivering at least a part of the transmitted microwaves into the medium, measuring with the means for receiving microwaves at least a part of the microwaves reflected in the medium, determining the parameters on the basis of the transmitted and received microwaves. This method can be practiced both in independent form and also in dependent form with the aforementioned method of the invention.

The term “clinical and/or chemical parameters” should be understood to mean in particular the following:
metabolic breakdown products or metabolites;
substances involved in metabolism;
leukocytes, in particular for ascertaining the degree of inflammation;
uric acid;
enzymes;
ions or ion concentration;
vitamins;
CRP (C-reactive protein);
substances in connection with anti-aging, well-aging and lifestyle;
microorganisms;
alcohol;
drugs;
lactate;
doping substances;
stains;
carcinogenic cells and structures;
contaminants, in particular wastewater contaminants;
quality control of liquid media, in particular water (laboratory values are obtained without the employment of reagents);
hormones;
bacteria;
crystals and their structures;
viruses.

Furthermore, the term “medium” should be understood to mean solid, liquid or also gaseous media or any mixed form of these media having any structure, thus in particular:
a human or animal body;
blood;
stain;
wastewater;
potable water (in the sense of high water quality);
metal workpieces joined by welding.

In what follows, the invention is described in greater detail with reference to the embodiments illustrated in the drawings. These are exemplary embodiments that aid in understanding the subjects claimed in the claims.

### BRIEF DESCRIPTION OF DRAWINGS

FIG. 1 depicts, in schematic representation, an apparatus according to the invention for determining a substance or a concentration of a substance as, respectively, a parameter or parameter concentration in a body;

FIG. 2A depicts, in schematic and perspective representation, a part of a laser unit, one cutting plane lying parallel to a longitudinal axis and a further cutting plane lying transversely to the longitudinal axis;

FIG. 2B depicts, in schematic and perspective representation according to FIG. 1A, a part of a further embodiment of a laser unit;

FIG. 3 depicts an exit window for employment in the case of the part of the laser unit illustrated in FIG. 2A or 2B;

FIG. 4 depicts the exit window according to FIG. 3 in a section parallel to the longitudinal axis according to FIG. 2A or 2B;

FIG. 5 depicts the fully assembled laser unit according to FIGS. 2A, 2B, 3, and 4;

FIGS. 6A and 6B each depict a section transverse to the longitudinal axis of a laser unit;

FIG. 7 is a schematic representation of a variant embodiment in which a mirror unit and an exit window are always arranged centrally relative to a laser diode unit;

FIG. 8 depicts a filter unit for employment in the apparatus according to FIG. 1;

FIG. 9 depicts a further embodiment of the filter unit in perspective representation;

FIG. 10 depicts a microprism unit for employment in the filter unit;

FIG. 11 depicts two masks lying one over the other for tuning the wavelengths to be passed;

FIG. 12 depicts a further embodiment of a filter unit having a photosensitive layer, in perspective representation;

FIG. 13 depicts a further embodiment of a filter unit having a photosensitive layer;

FIG. 14 depicts, in schematic representation, a part of a microwave unit in a section parallel to a longitudinal axis;

FIG. 15 depicts a cavity resonator having a further embodiment for a part of a microwave unit;

FIG. 16 is a detail view of the further embodiment for the part of the microwave unit according to FIG. 15;

FIG. 17 is a detail view according to FIG. 16 of a third embodiment for a part of a microwave unit;

FIG. 18 depicts the microwave unit according to FIG. 14 having an apparatus for aligning the microwave beam.

### DETAILED DESCRIPTION

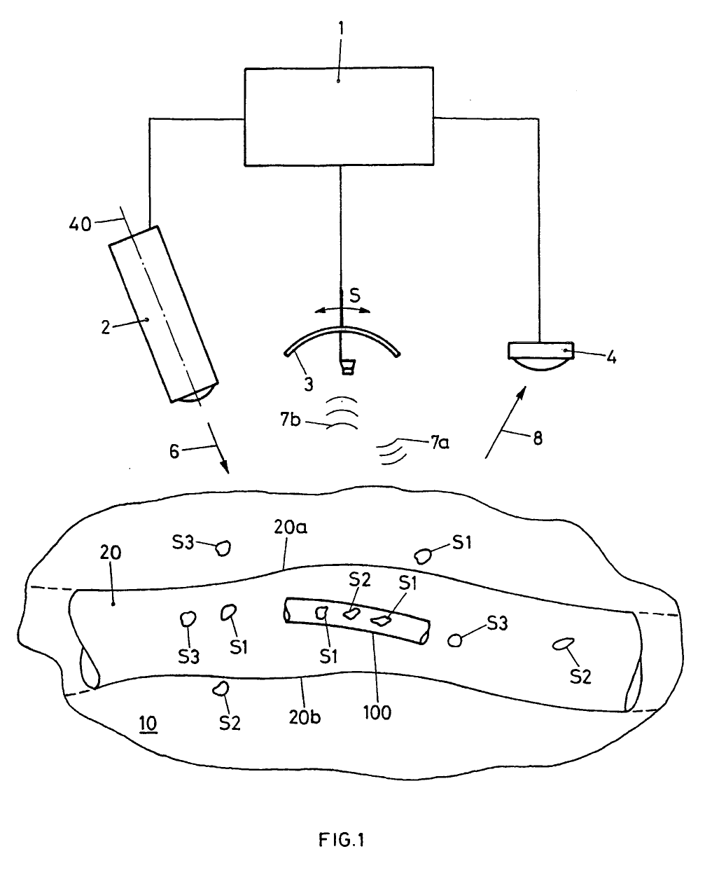

An apparatus according to the invention for the noninvasive determination of a substance in a body 10 is illustrated in schematic representation in an upper half of FIG. 1. The apparatus according to the invention comprises a monitoring unit 1, a laser unit 2, a microwave unit 3 and a phototransistor unit 4. Monitoring unit 1 is the actual unit guiding the process and conditioning the signals and to this end is in operative connection with laser unit 2, microwave unit 3 and phototransistor unit 4. While microwave unit 3 is suitable for both sending and receiving microwaves 7a, 7b, laser unit 2 is suitable only for emitting light waves 6. In order to receive light waves 8 reflected in body 10, phototransistor unit 4 is employed, which phototransistor unit consequently forms a measuring unit together with laser unit 2. It is explicitly pointed out that, according to the invention, it is not mandatory for both microwave unit 3 and the measuring unit comprising laser unit 2 and phototransistor unit 4 to be present in order that the invention can be reduced to practice. Instead, the invention can be excellently implemented with just one of the measuring units, that is, microwave unit 3 or laser unit 2 combined with phototransistor unit 4. Of course, the combination of the two apparatuses according to the invention, which are to be explained in detail below, yields the broadest possible employment.

Contained in monitoring unit 1 are amplifier units, signal-processing units, memory units, and other functional units, which of course could be mounted in separate units. The various functional units are combined into monitoring unit 1 in FIG. 1 solely for the sake of clarity.

The reference character 10 in FIG. 1 identifies a body as medium. This is for example a region of a living human body in which a substance S1 to S3 as parameter or a plurality of substances S1 to S3 are to be determined. Indicated in body 10 is an arterial blood vessel 20 having vessel walls 20a and 20b. Substances S1 to S3 are to be found both in blood vessel 20 and also in the other tissue, so substances S1 to S3 are transported by the blood flow in blood vessel 20 and can diffuse into the other tissue.

In what follows, the method according to the invention, which is performed with the use of the apparatus illustrated in FIG. 1 and is used for determining substances S1 to S3 or determining their concentrations in the blood, is explained in greater detail:

Initially, in a first phase, a measurement path 100 is established with the aid of laser unit 2, in which measurement path the measurements are to be carried out later. The objective here is to position measurement path 100 in the central region of arterial blood vessel 20. To this end, laser unit 2, which is a laser unit still to be explained in detail, is operated in the IR (infrared) range. It is known that the oxygen content is higher in arterial blood than in venous blood. Consequently, in dependence on the oxygen content at the location in question, a more or less strong reflection signal is obtained, which is measured with phototransistor unit 4. Thus, in the case of a strong reflection signal, it can be presumed that either an arterial blood vessel or a body tissue part strongly perfused with blood lies in the target region of the laser beam. Because items of information relating to the velocity of the particles present in the target region of the laser beam are additionally contained in the reflection signal, it can moreover be established whether an arterial blood vessel is actually present (higher velocity of particles) or whether only a body tissue part strongly perfused with blood is present (particles hardly move). Thus measurement path 100 is determined. It is possible and meaningful to verify whether measurement path 100 is at the location provided. The employment of a laser unit 2 is mandatory here because only lasers exhibit the required target accuracy.

In a further embodiment of the method according to the invention, a time point for the measurements performed in measurement path 100 is additionally determined in the first phase. If the location of measurement path 100 has been established in an arterial blood vessel 20 according to the previously described steps of the method, then the velocity profile in vessel 20 is substantially proportional to the heart cycle (QRS complex). It is then provided to determine a time window, established in relation to the heart cycle, in which the subsequent concentration measurement of one or a plurality of substances S1 to S3 is carried out. In a variant embodiment of the invention, for example, a time window of 100 ns is established, centered about the QRS complex or with respect to a pulse wave in the peripheral vessel.

If the spatial and also the temporal position of measurement path 100 have been determined according to the above steps of the method (Phase I), the actual determination of substance or substances of interest S1 to S3 can be begun (Phase II). To this end, two measurement methods find use, which can be active simultaneously:

The first measurement method is based on determining the optically visible spectrum in measurement path 100. Here, with laser unit 2, light pulses having wavelengths from 400 nm to a maximum of 1400 nm (spaced for example 25 nm apart) are transmitted. The echo signal is measured with phototransistor unit 4 as a light measuring unit in order to create the spectrum. Because of the tight time relationships and because not the entire spectrum is of interest, depending on what substance S1, S2, S3 is to be determined, only a certain wavelength range is traversed. In any case, the minimum light pulse width is equal to twice the wavelength.

In measuring the optical echo signal, phototransistor unit 4 is tuned in such fashion that selective measurement at specified wavelengths is possible. For example, phototransistor unit 4 can be tuned to a wavelength of 400 nm, which is referred to in what follows as frequency-selective or wavelength-selective tunability. Phototransistor unit 4 will be explained in detail further on.

This first measuring method is excellently suitable, for example, for determining the level of cholesterol, that is, of a substance that is present only in a relatively low concentration in the blood but, because of the structure, has a substantial effect on the optical spectrum.

A second measurement method, which, as noted, can be active at the same time as the first-mentioned, consists in counting substances S1, S2, S3 or their molecules to determine the concentration. Microwave unit 3 finds use for this purpose. The microwave unit transmits individual pulses of very short duration (for example 83 ps or 133.3 ps) into measurement path 100 determined during Phase I and scans the measurement path, the field strength of the echo signal received back by microwave unit 3 in each case yielding information about the presence, or the absence, of a certain substance S1, S2, S3 or of an atom of this substance.

In this way, by transmitting microwave frequencies determined ahead of time with reference to samples having the substances of interest, a plurality of images of the target regions having various wavelengths are created. These images are compared with previously measured patterns, which have been stored ahead of time in a memory unit belonging to monitoring unit 1 and can be retrieved for comparison in a pattern recognizer likewise contained in monitoring unit 1. In one embodiment, because of a limited memory in the memory unit, only known patterns of substances that are to be determined are stored.

This second measurement method is excellently suited, for example, to determining glucose in blood, that is, a substance that is present only in a relatively low, variable concentration in the blood. In addition, the glucose content cannot be determined correctly, that is, not with sufficient accuracy, from the optical spectrum.

In order to determine the concentration of other substances, for which both effects in the optical spectrum can be established and also enough particles can be detected with the aid of microwave unit 3, it is possible to combine the two measurement methods; that is, the results of both measurement methods are taken into account in determining the concentration.

In order to generate a laser beam having an exact wavelength, a laser unit 2 having a variable wavelength is used. Tuning of the desired wavelength is an absolute necessity in the case of the method according to the invention if one wishes to generate the various laser beams with the same laser unit.

The generation of laser beams having various wavelengths using the same laser unit is known in and of itself. Thus it has already been proposed to split the laser beam of a white light laser with the aid of filters or prisms in order in this way to extract the desired color components. It is further known to alter the dimensions of the resonator present in laser units with the aid of an appropriate mechanical system, so that the wavelength of the generated laser light can also be altered. In relation to the white light or colored light laser, reference is made to a press release from the University of Bonn, Germany, dated Sep. 16, 2003. This describes a new laser with which white light can be generated simply and inexpensively. The white light is decomposed into the color components with the aid of a suitable prism, it then being possible to select the required color. In relation to the first-named art, reference is made to the publication by Jeff Hecht titled “Understanding Lasers” (IEEE Press, 1992, pp. 296-297).

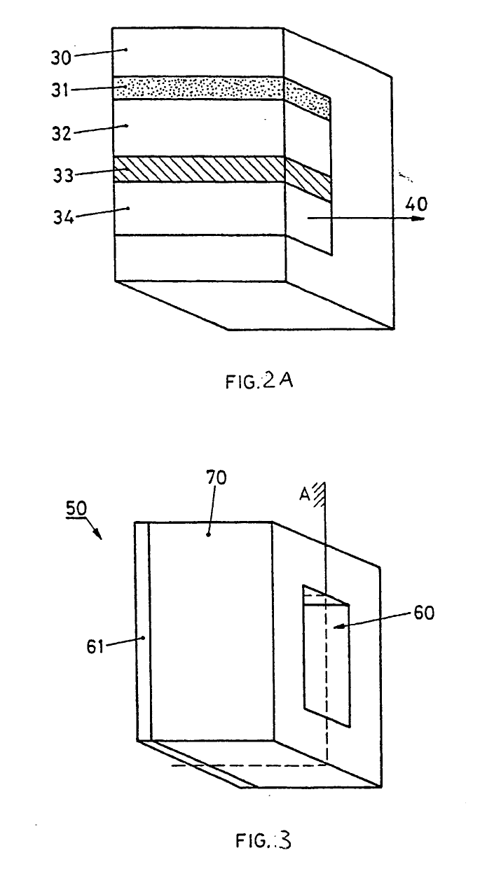

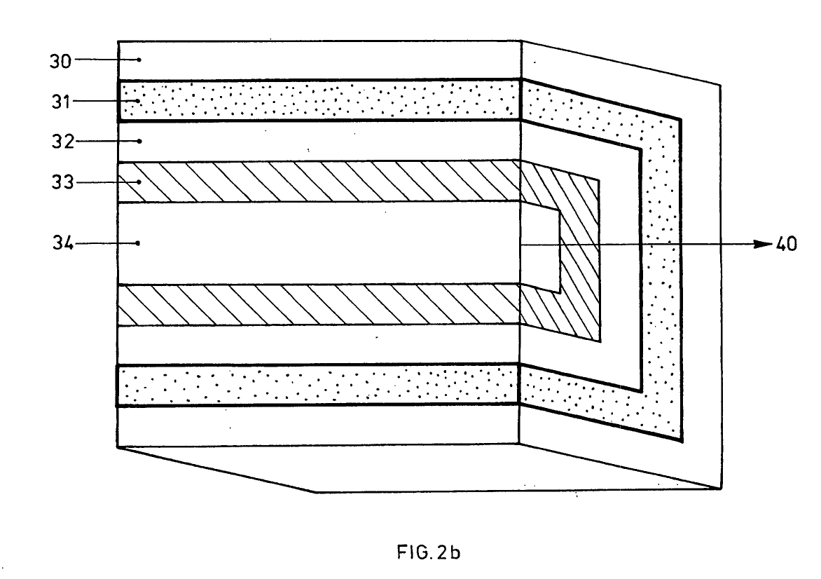

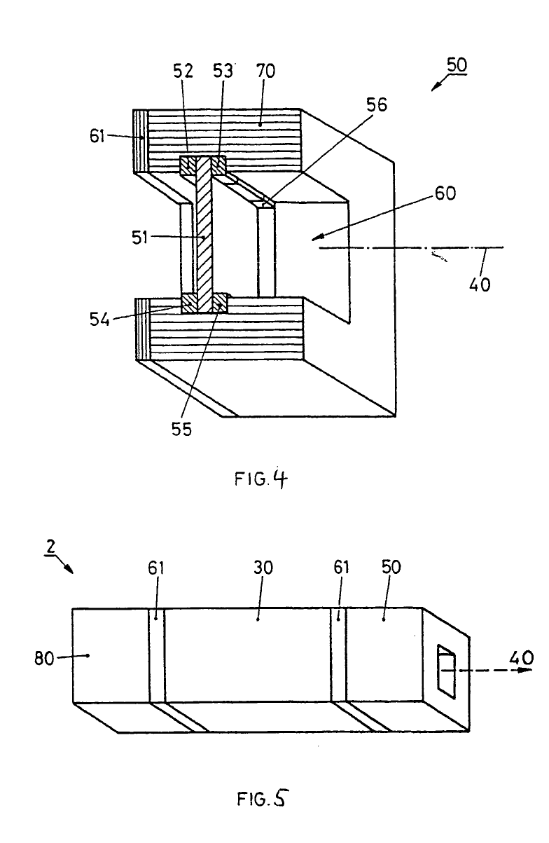

A laser unit 2 (FIG. 2), which is explained with reference to FIGS. 2 to 7, is particularly suitable for the apparatus illustrated in FIG. 1. This is a semiconductor laser unit that is based for example on gallium arsenide. Laser unit 2 is distinguished by high target accuracy. It is possible, for example, to generate wavelengths from 400 nm to 700 nm using laser unit 2. FIG. 2A depicts the schematic structure of a part of laser unit 2 with reference to a section parallel to a longitudinal axis 40. The light waves generated as laser beams propagate parallel to longitudinal axis 40, a mirror unit, and an exit window, which is implemented as a semitransparent window, not illustrated in FIG. 2A but explained with reference to FIGS. 3 and 4. The semitransparent window can also be, for example, a so-called Brewster window.

A support unit 30, which is made of a solid, thermally conductive material, for example brass or platinum, and can be regarded as a housing part, encloses a core proper of laser unit 2, specifically a laser diode unit 34, in which laser beams are generated in the junction region between the p-layer and n-layer in a manner known in the case of semiconductor lasers. The layer designated as laser diode unit 34 is, according to FIG. 2, located directly on support unit 30. There follow, starting from laser diode unit 34, a first insulation layer 33, a piezoelement 32 as a pressure-generating element, and a second insulation layer 31, which is in contact on its other side with enclosing support unit 30. In this way, piezoelement 32 is electrically insulated.

With the previously described design of laser unit 2, it is now possible, through a force generated in piezoelement 32, to act on laser diode unit 34 in order in this way to alter the wavelength, since the spacing between the valence band and the conduction band—and hence the wavelength—is dependent on the force acting on laser diode unit 34.

Piezoelement 32 is preferably fabricated from a tourmaline crystal provided with a silver film on its surface, which film was generated by evaporation and is employed for contacting and thus controlling entire piezoelement 32. In place of a silver film, aluminum or another metal film can also be applied by evaporation.

As has already been explained, generating a laser beam with laser unit 2 requires both a mirror unit and also an exit window, which are arranged substantially transversely to longitudinal axis 40 of laser unit 2 (FIG. 2A or 2B). While the rear mirror reflects the light beams generated by laser diode unit 34 as totally as possible, the exit window has the task of allowing light beams that satisfy predetermined conditions to escape from laser unit 2—right through the semitransparent window. Further information can be found in the publication “Understanding Lasers” by Jeff Hecht (pages 110 and 111, Second Edition, IEEE Press, New York, 1992).

A further embodiment of a part of laser unit 2 is illustrated in FIG. 2B with reference to a section parallel to a longitudinal axis 40, analogously to FIG. 2A. As already in the embodiment according to FIG. 2A, support unit 30 of the embodiment according to FIG. 2B also forms a cavity in which there are contained two insulation layers 31 and 33, a piezoelement 32 and a laser diode unit 34. In contrast to the variant embodiment according to FIG. 2A, laser diode unit 34 is initially enclosed by first insulation layer 33, next by piezoelement 32 as a pressure-generating element, then by second insulation layer 31, and finally by support unit 30. In this way it is possible to generate with pressure-generating element 32 a force that acts on laser diode unit 34 from all radial directions, that is, substantially perpendicularly to longitudinal axis 40.

Illustrated in FIG. 3 is an exit window 50 as it is arranged axially on support element 30 illustrated in FIG. 2. Exit window 50 essentially comprises a frame element 70 and a laterally arranged insulation layer 61, an opening 60 being provided both through frame element 70 and through insulation layer 61. Further drawn in FIG. 3 is a cutting plane A-A, which forms the basis for the section through exit window 50 illustrated in FIG. 4.

FIG. 4 depicts exit window 50, illustrated in FIG. 3, in section along cutting plane A-A (FIG. 3). Through the section parallel to longitudinal axis 40, frame element 70 becomes a U-shaped part into which there is inserted a semitransparent window 51, which stands substantially perpendicular to the propagation direction, that is, to longitudinal axis 40. A displacement of semitransparent window 51, both translationally cholesterol in the axial direction and also as a tilting movement about longitudinal axis 40, is achieved with the aid of positioning elements 52 to 56 (also referred to more generally as displacement elements in what follows), which in turn are fashioned as piezoelements. So that there will be three degrees of freedom for the movements of semitransparent window 51, positioning elements 52 to 56 in the embodiment illustrated in FIG. 3, are arranged at the corners of four-cornered semitransparent window 51. Further, positioning elements 52 to 56 are individually contacted via an electrical connection so that positioning elements 52 to 56 can be driven independently of one another. Control takes place for example via a central control unit, which is not further illustrated.

The mirror unit, which is to reflect the light beams generated in laser diode unit 34 (FIG. 2) in as total and lossless a fashion as possible, can be implemented as a fixed mirror surface in accordance with the prior art.

In a further embodiment of the invention it is proposed to implement the mirror unit not as fixed, but analogously to semitransparent window 51, explained with reference to FIGS. 3 and 4. In this variant embodiment, to be sure, no semitransparent window is necessary. For this reason, in place of the semitransparent window 51 illustrated in FIG. 4, what is needed is a reflective surface that is obtained for example by evaporating a metal film onto a support. The remaining elements, that is, the positioning or displacement elements, are employed for controlling the reflective surface. In this way there is created a laser unit 2 that has an application range expanded relative to the embodiment having a fixed mirror surface (mirror element), as will become particularly clear in light of the discussion that follows.

In order to obtain a resonance in a laser unit, it is known to be of decisive importance that the spacing between the mirror surface (mirror element) and the semitransparent window be a multiple of, or exactly equal to, half the wavelength of interest (λ/2). If now the wavelength is altered by alteration using piezoelement 32 (FIG. 2), then an efficient laser unit (i.e., maximally coherent light) can be obtained above all when the spacing between the mirror surface and semitransparent window 51 is set as a multiple of, or equal to, half the wavelength of interest.

It has been found that, through the combination of force exertion on laser diode unit 34 from all sides (FIG. 2B) and the simultaneously performed correct setting of the spacing between the mirror surface and semitransparent window 51, there is made available a laser unit 2 (FIG. 2) having extreme versatility of setting, which is distinguished in particular in that the wavelength can be set electrically between, for example, 400 nm and 700 nm without the need for prisms or chromatic filters and without the need to perform frequency doubling.

FIG. 5 depicts laser unit 2 comprising the individual parts explained with reference to FIGS. 2A, 2B, 3, and 4. Thus support element 30 according to FIG. 2 is arranged between frame element 50 having the semitransparent window and a mirror unit 80, an insulation layer 61 being present for electrical and thermal insulation between individual parts 80, 30, 56.

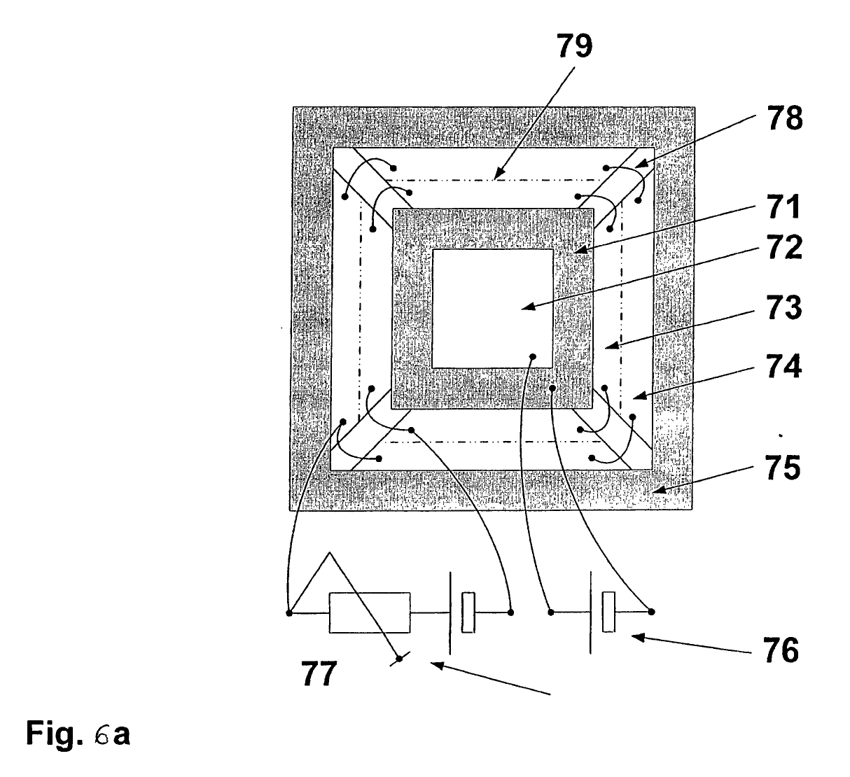

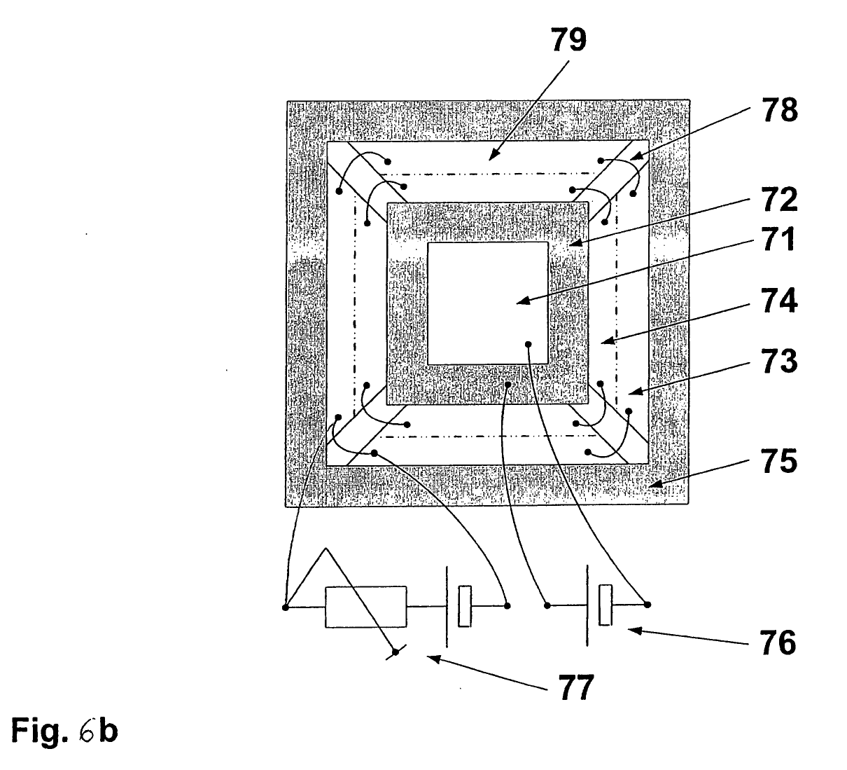

FIGS. 6A and 6B depict laser diode units fabricated by epitaxy or also by other methods, which laser units exhibit pressure-generating elements 73, 74 on all four sides of the square cross section, the four parts of pressure-generating elements 73, 74 being spaced apart at each of the corners. In order to actuate all four parts of pressure-generating elements 73, 74 simultaneously, these are electrically connected to one another with the aid of bond wires (as illustrated in FIGS. 6A and 6B) or are directly coupled to a voltage source or control unit 77 provided for this purpose. For further clarification, a p-n junction is illustrated in FIG. 6A and an n-p junction in FIG. 6B for the laser diode unit. From FIGS. 6A and 6B it is apparent that pressure-generating elements 73, 74 have opposite poles relative to the laser diode unit, so that a mutually unfavorable influence between the pressure-generating element and the laser diode unit can be prevented.

The reference characters employed in FIG. 6A or 6B can be identified as follows:
71 n (cathode) of laser diode unit;
72 p (anode) of laser diode unit;
73 n terminal of pressure-generating element;
74 p terminal of pressure-generating element;
75 support element;
76 source for the laser diode unit;
77 control circuit for setting the force acting on the laser diode unit;
78 air gap between the individual parts of the pressure-generating unit;
79 pressure-generating element.

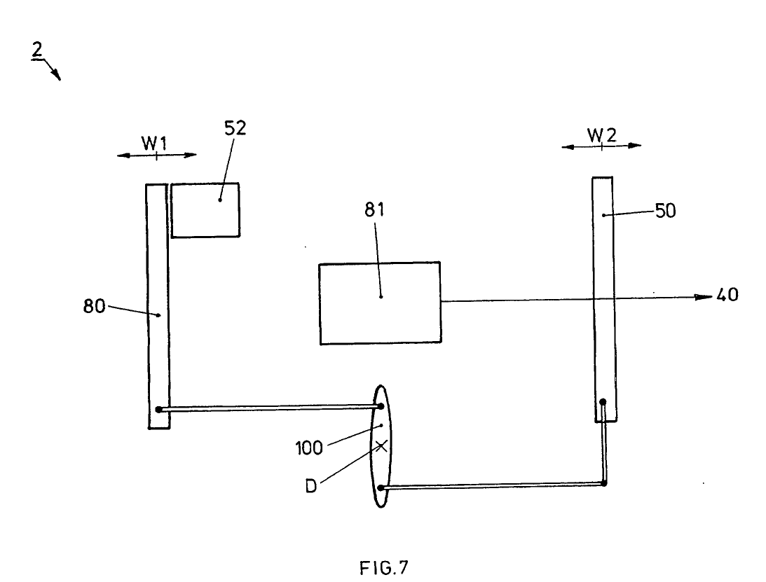

In schematic representation, FIG. 7 depicts a device according to the invention, having the central part of laser unit 2 arranged centrally between mirror unit 80 and exit window 50, which laser unit is implemented, for example, in the fashion described in connection with FIG. 6A or 6B. This embodiment is distinguished in that both mirror unit 80 and also exit window 50 are displaced in dependence on the force generated by the pressure-generating element (not shown in FIG. 7) and acting on the laser diode unit, and specifically in such fashion that the laser diode unit is always located centrally between the mirror unit 80 and exit window 50 or that the diode laser facet is half the wavelength or a multiple of half the wavelength away from the mirror unit, this being dependent on whether the diode laser facet is antireflection-coated or not. Specifically, if the diode laser facet is antireflection-coated, no additional resonance builds up between the diode laser facet and the mirror unit. If, on the other hand, the diode laser facet is not antireflection-coated, then an additional resonance builds up between the diode laser facet and the mirror unit, leading to additional waves and thus to a loss if the distance is incorrect. This occurs with deviations that depend on the distance of the mirror units relative to the diode laser facet and applies to both exit ends of the laser diode unit. This is achieved, for example, with the aid of the synchronous rotation device 100 illustrated in FIG. 7, which is rotatably mounted at point D. If, now, mirror unit 80 is displaced with displacement element 52 in a direction W1, a 1:1 transmission to exit window 50 takes place via synchronous rotation device 100, so that the exit window experiences a displacement of identical magnitude in direction W2.

As an additional advantage, central alignment of the laser diode unit or its facet yields optimized power utilization.

In place of synchronous rotation device 100, there can of course be two or a plurality of displacement elements 52 that are matched and arranged in such fashion that the laser diode unit is always located centrally between mirror unit 80 and exit window 50.

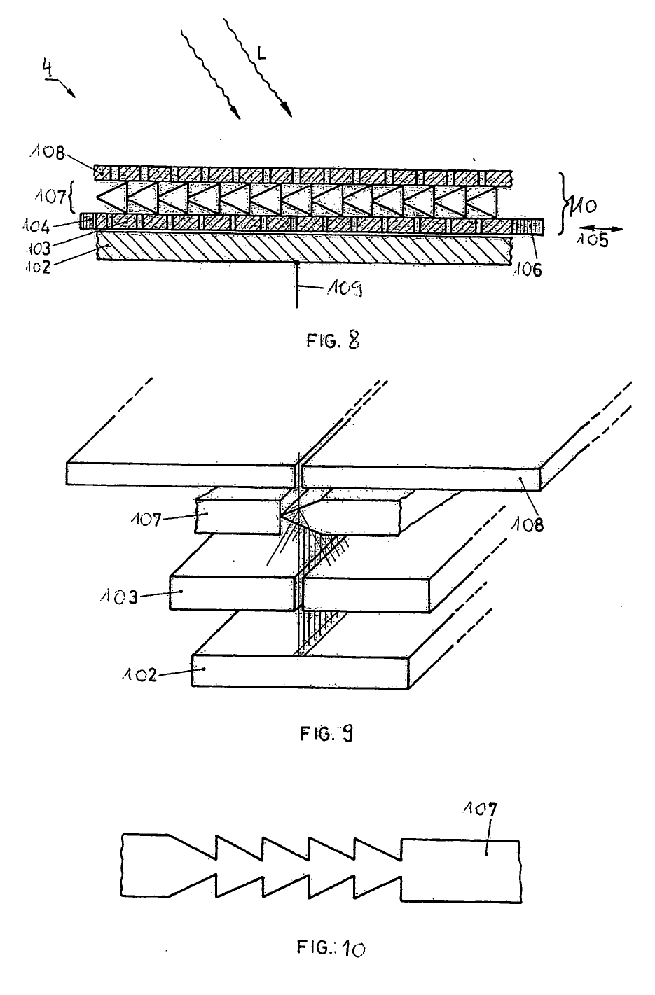

For the in connection with the apparatus according to the invention illustrated in FIG. 1, a with reference to phototransistor units 4 (FIG. 1) explained in FIG. 8 to 13 is particularly suitable.

The phototransistor unit 4 illustrated in FIG. 8 essentially comprises a photosensitive layer 102, which is implemented for example with one or a plurality of phototransistors, and a filter unit 110 arranged in front of photosensitive layer 102. Filter unit 110 has a movable slit mask 103, a microprism unit 107, and a fixed slit mask 108. Movable slit mask 103 can be moved in the directions indicated by an arrow 105, substantially laterally to slit mask 108, and specifically with the aid of displacement units 104 and 106 arranged laterally in relation to movable slit mask 103.

In one specific embodiment, one displacement unit 104 is implemented with the aid of a piezounit and the other displacement unit 106 is implemented as a viscous spring element. Here the viscous spring element comprises, for example, a silicone insert, an insert made of natural rubber, or a steel spring. When a silicone insert is employed, a buffer layer is necessary in order to prevent migrations of material.

A further concrete embodiment for displacement elements 104 and 106 consists in the use of microsteppers or microlinear motors, which likewise make possible high precision in the displacement of movable mask 103.

Prism unit 107 is arranged between fixed and movable slit masks 108 or 103, masks 103, 108 having corresponding first and second apertures that form an aperture pair. Prism unit 107 has one prism for at least one aperture pair.

In a further embodiment of the arrangement, which is not illustrated in FIG. 8, instead of movable slit mask 103 the position of microprism unit 107 is altered with the aid of displacement units, which are once again implemented for example in the form of a piezounit and a viscous spring element. Also in this way it is possible to convey selectively those light waves L through slit mask 103, which in contrast to the embodiment according to FIG. 8 is now positionally fixed, onto photosensitive layer 102. Microprism unit 107 is moved substantially laterally to slit mask 103 or slit mask 108.

A still further embodiment of filter unit 110 consists in that both slit masks are movable. Excursions of the individual slit masks are reduced in this way because each of the slit masks is moved through half of the travel to be covered. The slit masks here move in laterally contrary fashion.

The filter unit 110 described thus represents a color filter in which the filtered wavelengths can be tuned in electronic fashion. Furthermore, filter unit 110 is a temperature-independent color filter that can be tuned for example to wavelengths from 1400 to 430 nm. Filter unit 110 and thereby phototransistor unit 1 as a whole are distinguished by one or a plurality of the following advantages:
the structural form of filter unit 110 or, respectively, of phototransistor unit 1 can be chosen to be extremely small;
precise, electronic tunability of the desired wavelength of those light beams that are to impinge on photosensitive layer 102;
minimal mechanical effort;
extremely short reaction times;
increase in the sensitivity of phototransistor unit 1 when all the aperture pairs are tuned to a wavelength or to the same wavelength range in which measurement is to take place. Then, specifically, the signals measured on the photosensitive layer can be added, which leads to larger signal contents.

In order for accurate measurement results to be obtained with phototransistor unit 1, a calibration must be carried out ahead of time. Such a calibration can for example be performed as follows:

Phototransistor unit 1 is exposed to a light source having a known wavelength. Movable slit mask 103 or 108—or, as appropriate, microprism unit 107, provided this is movable—is then displaced with the aid of displacement units 104, 106 until a signal maximum is obtained on photosensitive layer 102. The corresponding degree of displacement in dependence on the displacement mechanism employed can be held constant for calibration. If piezoelements are employed as active displacement units, the electrical signal applied to the piezoelements can be related to the wavelength of the light source, so that the calibration for this wavelength is complete. Further calibrations with other wavelengths of the light sources are advantageously carried out in order to ascertain nonlinearities, if any.

It has been found that microprism unit 107 can be fabricated from a substance having the chemical formula NaCl in crystalline form.

FIG. 9 depicts, in perspective representation, a further embodiment of the filter unit. In contrast to the embodiment according to FIG. 8, this embodiment exhibits just one slit in slit masks 103 and 108. Microprism unit 107 correspondingly exhibits a single prism. An incident light beam is parallelized by slit mask 108. The parallelized light beam is then broken down by microprism unit 107 into light components of various wavelengths. The light component of interest is selected with the aid of movable slit mask 103 by positioning movable slit mask 103 appropriately. In this way, only the light having the desired wavelength falls on photosensitive layer 102 and is measured.

A further embodiment consists in employing hole masks instead of slit masks. In this way the corresponding images on the photosensitive layer become not strip-shaped but dot-shaped.

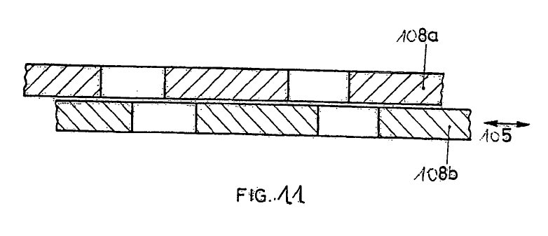

FIG. 10 depicts a microprism unit 107 as it is employed for example in the embodiment according to FIG. 8. Microprism unit 107 is fabricated for example from glass into which the individual prisms have been ground. In the fabrication of the microprism unit it should be noted that the individual prisms are in accord with the corresponding dimensions of the slit masks or hole masks, that is, that the arrangement of a slit or a hole coincides with the corresponding prism, so that the desired wavelengths or wavelength ranges can be measured. The corresponding slits or holes are generally designated as aperture pairs, which correspondingly comprise first and second apertures.

In a further embodiment, microprism unit 107 is made of a polymer instead of glass. Fabrication is simplified in this way and the costs are less than when glass is employed. Combining individual prisms in order to form the microprism layer is also conceivable. The individual prisms are then cemented together with an adhesive.

As has become clear from the foregoing discussion, in particular in connection with the variant embodiments according to FIGS. 8 to 10, an application of the filter unit consists in combining the filter unit with a photosensitive layer 102. In this way there is obtained a phototransistor unit with which extremely accurate measurements can be made in a certain wavelength range, electronic tuning of the wavelength to be measured being possible.

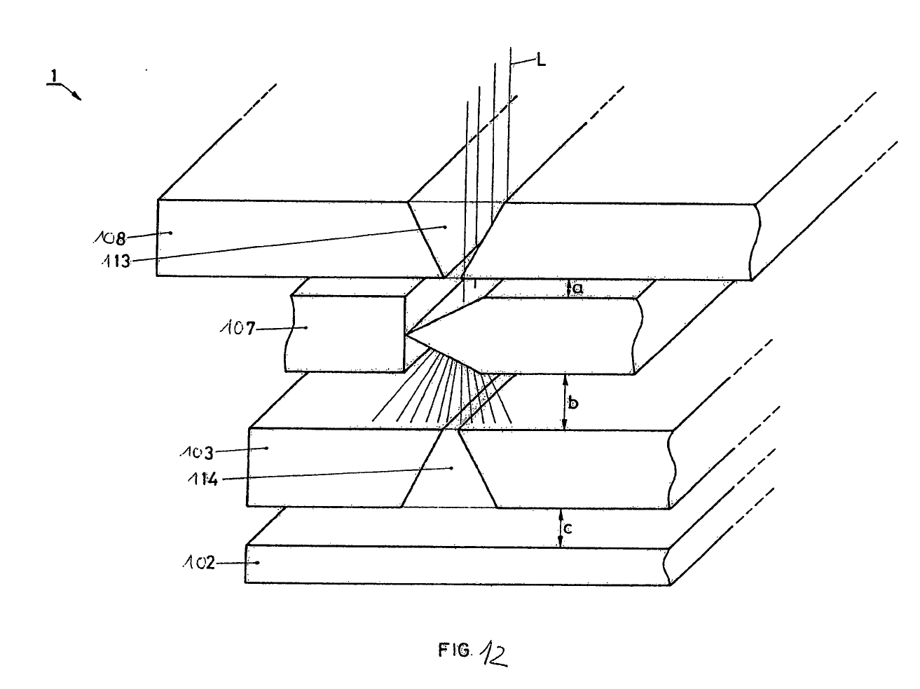

A further embodiment of the filter unit consists in that the wavelengths passed by the slit mask or hole mask are tunable. Provided to this end as the mask are two masks lying one over the other, as they are identified in FIG. 8 with the reference characters 103 and 108, which masks can be laterally displaced one relative to the other. Such an embodiment is illustrated in FIG. 11, two masks 108a and 108b lying one directly over the other, which masks can be laterally displaced one relative to the other—for example once again with piezoelements in combination with viscous spring elements. In this way the slit size or hole size is altered; consequently, a slit mask or hole mask is obtained in which the aperture is adjustable. Depending on the application, the slit mask or hole mask having an adjustable aperture can be above the microprism unit, that is, on the side of light source L, or beneath the microprism unit. Moreover, it is also conceivable that the aperture of the slit masks or hole masks is adjustable in the sense of the foregoing discussion both above and also beneath the microprism unit.

FIG. 12 depicts a further embodiment of a filter unit 1 having a movable slit mask 108, a prism unit 107, a fixed slit mask 103, and a photosensitive layer 102 corresponding to the embodiment illustrated in FIG. 9. In contrast thereto, the embodiment according to FIG. 12 exhibits on the one hand a movable slit mask 108, whose side walls forming the slit have a conical shape, and indeed the slit is narrower on the light exit side than on the light inlet side. On the other hand, fixed slit mask 103 likewise exhibits conically shaped side walls, but in reversed direction, so that the slit width is smaller on the light inlet side than on the light exit side. In other words, the slid width is smaller on the side of prism unit 107 than on the side of photosensitive layer 102.

In a variant embodiment, the slit of movable slit mask 108 is equipped with converging optics 13 and/or the slit of fixed slit mask 103 is equipped with a diffuser 14. While a larger quantity of light or rather a larger number of light quanta is obtained by converging optics 13 and falls on prism unit 107, light monochromatically exiting through prism unit 107 is distributed by diffuser 14 in substantially uniform fashion and over a large area of photosensitive layer 102. The net result is higher sensitivity of the phototransistor unit.

In FIG. 12, the distance between movable slit mask 108 and prism unit 107 is designated by a, the distance between prism unit 107 and the fixed slit mask by b, and the distance between fixed slit mask 103 and photosensitive layer 102 by c. It has been found that distances a and c are preferably chosen to be as small as possible. Distance b is preferably variable and thus serves to limit or adjust the bandwidth—or the wavelength range—of the light beams passing through the slit of fixed slit mask 103.

It is pointed out that the conical shape—that is, the steepness of the side walls bounding the slit—of fixed slit mask 103 is chosen in such fashion that the relevant measurement region on the photosensitive layer is illuminated in full-area fashion. In this way it is ensured that no errors will be present in the measurement results, since non-full-area illumination of a phototransistor generally leads to measurement errors.

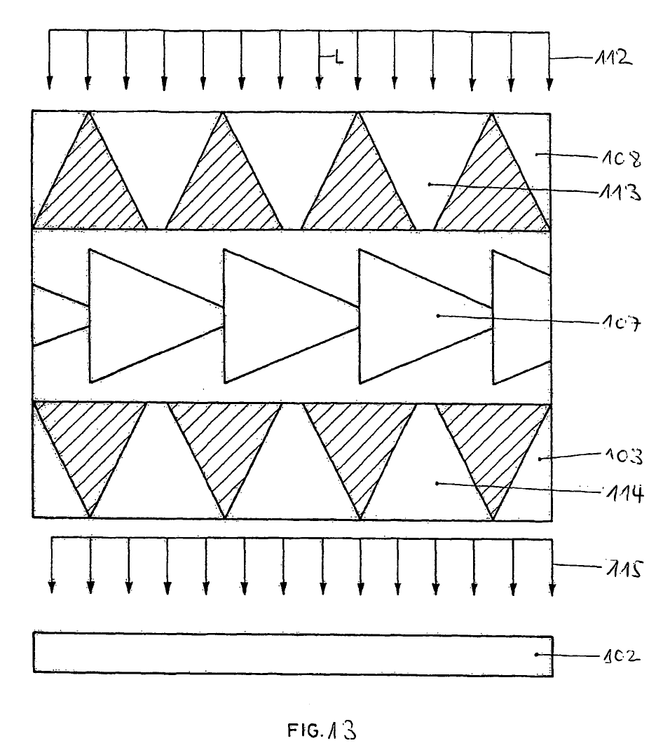

FIG. 13 illustrates a further embodiment of the filter unit according to the invention having a photosensitive layer 102 having a plurality of slits or holes in slit mask or hole mask 108, analogously to the embodiment according to FIG. 8. The reference character 12 designates mixed light and 15 designates monochromatic light, the latter alone being incident on photosensitive layer 102.

In the embodiment having a movable slit mask 108, the side walls forming the slit have a conical shape, the slit aperture being chosen as a maximum on the light inlet side, so that as much light as possible can be incident in each slit. Correspondingly, the side walls forming the slits come together at a point, which in each case coincides with the top side of movable slit mask 108. On the other hand, fixed slit mask 103 is arranged in the opposite way in the sense that the wide aperture comes to lie on the side of photosensitive layer 102. Diffuser 14 contained in the slit ensures that the photosensitive layer is maximally and uniformly illuminated, so that higher sensitivity and more accurate measurement results are obtained.

In a further embodiment of the invention, the conically shaped side walls of the slit are provided with a reflective coating in order to increase the luminous efficiency further.

In a further embodiment, for which the cross-sectional representation according to FIG. 13 is likewise valid, there are holes instead of slits in masks 108 and 103. The holes in masks 108 and 103 therefore have a truncated conical shape, as are the inserts let into masks 108 and 103 as converging lenses 13 in the case of movable hole mask 108, or as diffuser 14 in the case of fixed hole mask 103.

It is explicitly pointed out that—as already explained in connection with the embodiments according to FIGS. 8 and 9—movable mask 108 can also be fashioned as fixed and fixed mask 108 can be fashioned as movable, even in the embodiments according to FIGS. 12 and 13. What is more, constellations according to FIG. 11 are likewise conceivable in the embodiments according to FIGS. 12 and 13.

It was already pointed out that the microprism units are made of crystalline NaCl, glass, or a polymer. Crystals, precious stones such as for example diamonds for high color purity, quartz, or neodymium are further conceivable.

It is further pointed out that in all the embodiments previously mentioned, so-called multiple prisms can be employed in the microprism units or in the prism units. Such multiple prisms, also more generally called direct-vision prisms, are assembled from a plurality of prisms having various materials, for example various grades of glass, so that the central ray passes through substantially undeflected despite a spectral deflection. Further information on multiple prisms can be found for example in DE-37 37 775 A1.

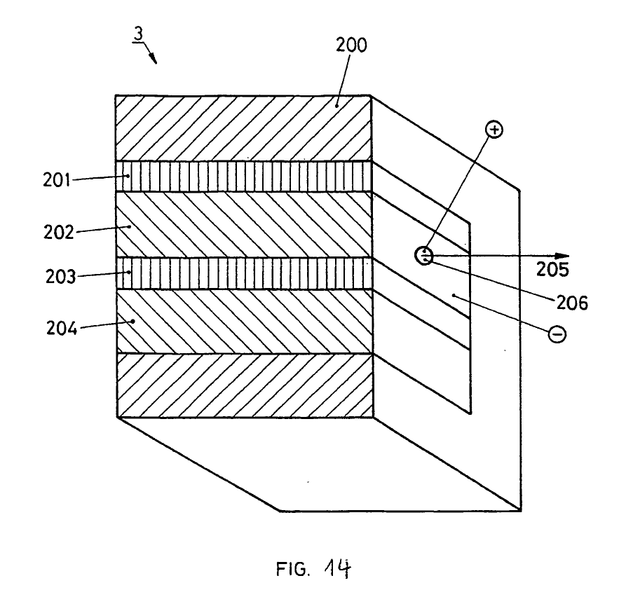

Finally, FIG. 14 illustrates an embodiment for microwave unit 3 referred to in connection with FIG. 1. This is a possible schematic structure of a part of microwave unit 3 with reference to a section parallel to a propagation direction 205 of the microwaves. Like laser unit 2 explained with reference to FIG. 2, microwave unit 3 (FIG. 1) includes a support unit 200 made of a material capable of bearing load, for example brass or platinum. Large forces can thus be accommodated as necessary. Contained in the interior of support unit 200, in a compact construction, are the following layers, starting from an upper support wall: a first insulation layer 201, a Gunn diode 202, a second insulation layer 203 and a piezoelement 204. Various control lines, having corresponding contact points for controlling the individual layers from monitoring unit 1 (FIG. 1), are not depicted in FIG. 14.

Gunn diode 202 is a diode based on the Gunn effect (John Gunn, 1963), which is used in known fashion for generating microwaves. For further information on the Gunn effect or on Gunn diodes, reference is made to the standard work by Donald Christiansen titled “Electronics Engineers' Handbook” (McGraw-Hill, Fourth Edition, 1997, pages 12.71 as well as 12.79 and 12.80) as being representative. This publication also cites further standard works on this topic.

According to the foregoing discussion, Gunn diode 202 is clamped in between first insulation layer 201 and second insulation layer 203. With the aid of piezoelement 204, the frequency of the microwaves generated by Gunn diode 202 can now be tuned, for example between 8.7 and 12 GHz. Here the frequency shift is effected on the one hand by pressure on Gunn diode 202 (that is, the so-called “die”) itself, by which a material alteration arises in the interior of Gunn diode 202 as a consequence of the molecular vibration alteration—similarly to the case of a large change in temperature—and on the other hand by an alteration of the capacitance due to a change in the distance from Gunn diode 202 to support unit 200—similarly to a change in capacitance in a capacitor in which the capacitor plates are displaced relative to one another. Via piezoelement 204, it is thus possible to tune the frequency generated with Gunn diodes 202 in exact fashion. The microwave unit 3 described is thus distinguished from known apparatuses in particular in that the frequency of the generated microwaves can be exactly tuned in electronic fashion without mechanical adjustment devices.

So that the frequency of microwaves 205 to be transmitted will remain constant once tuned, piezoelement 204 in a further embodiment of microwave unit 3 is provided with a so-called PLL (phase-locked loop) or FLL (frequency-locked loop) circuit known of itself. One of these circuits regulates the voltage imposed on piezoelement 204 in such fashion that the desired frequency of microwaves 205 remains constant.

The reference character 206 denotes a window for the exit of microwaves 205 to the side of Gunn diode 202. Window 206 is preferably obtained by suitable doping with foreign atoms. In this way, a controlled exit of microwaves from Gunn diode 202 is made possible. Suitable in particular for doping is GaAs (gallium arsenide). The diameter of window 206 is for example approximately 10 μm and the depth of doping is for example 320 A (angstroms). In addition, the +/− terminals are drawn in FIG. 14, electrical contacting of the first-named taking place in window 206 and electrical contacting of the second-named taking place outside window 206.

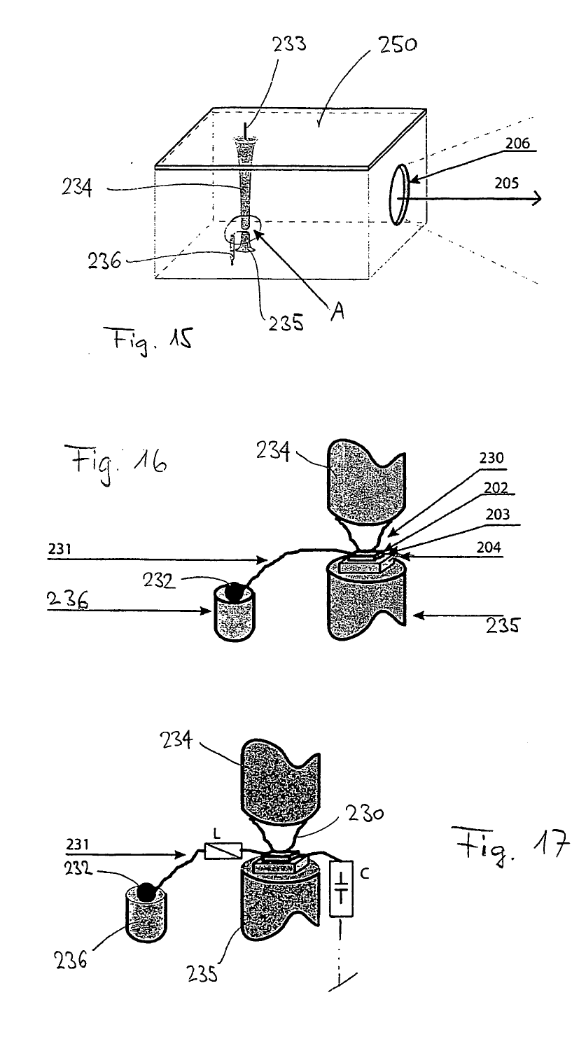

An embodiment for a microwave unit 3 (FIG. 1) is illustrated schematically in FIG. 15. The reference character 250 denotes a cavity resonator, in which the part of microwave unit 3 explained with reference to FIG. 14 can also be contained. FIG. 15 depicts an alternative embodiment to FIG. 14, which is described in detail with reference to FIG. 16.

Cavity resonator 250 is made of metal and has an exit hole 251 through which the microwaves exit from cavity resonator 250 in propagation direction 205. Contained in cavity resonator 250 are on the one hand a ceramic body 234, which extends from above into the interior of cavity resonator 250, and on the other hand a body 235 that extends from below into the interior of cavity resonator 250, upper ceramic body 234 and body 235 being directed toward each other, that is, exhibiting a common axis, but not touching. Beside body 235 there is further arranged an additional ceramic body 236, which is explained with reference to the detailed view in FIG. 16. Body 235 is made of a metal, for example of brass or copper, and serves as a cathode. At the same time, excess heat can be removed via body 235.

From FIG. 16, which is a detail view A according to FIG. 15, it is apparent that lower ceramic body 235 is as a support element for the following units or layers respectively (in order starting from ceramic body 235):

a piezoelement 204;

a contact layer 203 made of a metal, for example of silver or copper;

a Gunn diode 202.

For controlling piezoelement 204 there is a control line 231, which is connected to a contact point 232 on additional body 236. Contact point 232 is led out of cavity resonator 250 via an electrical conductor contained in additional body 236, so that it is possible to drive piezoelement 204 from outside cavity resonator 250. Gunn diode 202 arranged above contact layer 203 is further connected via a contact loop 230 to ceramic body 234, which simultaneously serves as feedthrough capacitor and makes possible the contacting of Gunn diode 202 from outside cavity resonator 250.

According to the foregoing explanations, Gunn diode 202 is mounted on contact layer 203 and piezoelement 204. The frequency of the microwaves generated by Gunn diode 202 can now be tuned, for example between 8.7 and 12 GHz, with the aid of piezoelement 204. Here the frequency shift is effected on the one hand by the capacitance change due to a change in spacing between Gunn diode 202 and body 235 acting as the cathode, and on the other hand by the position change relative to ceramic body 234 acting as the feedthrough capacitor. Thus, via piezoelement 234, it is possible to tune and alter the frequency of the microwaves generated with Gunn diode 202 in exact fashion. This embodiment is thus also distinguished from known microwave units in that the frequency of the microwaves generated can be tuned in electronic fashion.

A further advantage of this variant embodiment is the very small structural form of, for example, 2×1×1 mm for the external dimensions of cavity resonator 250, which has only three terminals, namely V_{gnd}, V_{Gunn} and V_{piezo}, V_{gnd} being equal to the common ground or bond potential, V_{Gunn} to the supply voltage or the signal pickoff of the Gunn diode, and V_{piezo} to the supply voltage of the piezoelement and the oscillator circuit tuning connected therewith. The self-contained cavity resonator has little susceptibility to external influences, because all the components exhibiting high frequency are contained in the cavity resonator. This circumstance makes it nearly ideal for application in microsensor technology.

As has already been mentioned in connection with the discussion of the variant embodiment according to FIG. 14, the tuned frequency of the microwaves to be transmitted can be held constant with the aid of so-called PLL (phase-locked loop) or FLL (frequency-locked loop) circuits, which is naturally also conceivable in the case of this embodiment.

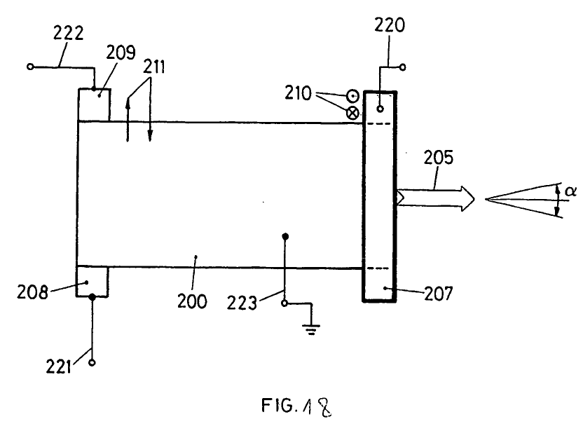

FIG. 17 depicts a variant, augmented relative to the embodiment according to FIG. 16, having an additional inductance and an additional capacitance. In this way, high-frequency signal components or microwaves are prevented from escaping from the cavity resonator at undesired places.

FIG. 18 depicts support unit 200 in lateral view, reference character 205 once again identifying the microwave beam that is generated in Gunn diode 202 (FIG. 14). By embedding support unit 200 with displacement elements 207 to 209, each of which is formed from a piezoelement, support unit 200 as a whole can be displaced or tilted; in other words, the direction of microwave beam 205 can be set. In order that the largest possible region can be covered with the microwave beam, displacement element 207 and its mating part (not visible in FIG. 8 because it is covered by displacement element 207) are mounted in the region of the exit opening of the microwave beam. With these displacement elements 208, support unit 200 can be moved perpendicularly to the drawing plane, in correspondence with the arrows characterized with 210, which are perpendicular to the drawing plane.

The two further displacement elements 208 and 209 are arranged on the opposite end of support unit 200, and indeed in such fashion that support unit 200 can be moved in the drawing plane of FIG. 18 in correspondence with the arrows characterized with 211. Consequently, displacement elements 208 and 209 act on two of the parallel surfaces of support unit 200, while displacement element 207 and its mating part act on the other two of the parallel surfaces of parallelepiped-shaped support unit 200.

For trouble-free contacting of displacement elements 207 to 209, these are provided on their outer side with, preferably, a silver film. This makes possible simple contacting with control lines 220 to 222 through known bonding technology. Associated therewith is a reference connection 223 for establishing a reference potential. To this end, reference connection 223 is connected to support unit 200, preferably once again by bonding technology.

With the positioning device described, the microwave beams can be tilted about two axes, so that a cone of approximately 2.5° can be traversed. If further displacement elements are used, which act on the third pair of surfaces of support unit 200, then a translational movement in a third axis can be brought about.

Gunn diodes are known to be used both as sending units and as receiving units. Correspondingly, microwave unit 3 is used not only for sending but also, in analogous fashion, also for receiving microwaves.

It is again explicitly pointed out that the present invention exhibits a broad spectrum of possible applications. Although the noninvasive determination of substances, that is, of glucose and cholesterol, in the human body has been cited as an exemplary embodiment, the present invention is excellently suited to the contactless determination of any clinical and/or chemical parameters, as they were non-conclusively enumerated at the outset. On the basis of the enumeration as possible clinical and/or chemical parameters that can be determined with the method according to the invention or with the corresponding apparatus, the following applications result directly:
automatic analyzers for determining clinical parameters up to and including DNA determination;
doping test for sports events: The method according to the invention permits a rapid, noninvasive test;
mobile alcohol test: Here again, noninvasive determination proves to be particularly advantageous;
in the coloring substances industry, accurate formulation of the color pigments in question is of particular importance;
contactless determination of contaminants in wastewater: With the method according to the invention, compositions of substances can be determined without the need to take samples. In this way, highly toxic substances can be investigated without danger.
The invention is excellently suited to any microbiological application involving the detection of viruses or bacteria; it is immaterial whether the viruses or bacteria to be determined are contained in a solid, liquid, or gaseous medium.
Inspection of welds: Microcracks can be detected with high reliability by the method according to the invention.

1. A method for determining clinical and/or chemical parameters (S1) in a medium (10), utilizing
means (2) for transmitting coherent light waves (6) and means (4) for receiving light waves (8), the method comprising:
delivering at least a part of the transmitted light waves (6) is delivered into the medium (10),
measuring with the means (4) for receiving light waves (8) at least a part of the light waves (8) reflected in the medium (10),
determining the parameters (S1) on the basis of the properties of the transmitted and received light waves (6; 8).

2. Method according to claim 1, including tuning the frequency or wavelength of the coherent light waves (6) in accordance with characteristics of the parameters (S1) to be determined.

3. Method according to claim 1, including tuning the means (4) for receiving light waves (8) in frequency-selective or wavelength-selective fashion.

4. Method according to claim 1, including operating the means (2) for transmitting coherent light waves (6) so as to generate wavelengths between 400 and 1400 nm.

5. Method according to claim 1, including determining cholesterol as parameter (S1) according to concentration in the blood.

6. A method for determining clinical and/or chemical parameters (S2) in a medium (10), according to claim 1, further utilizing
means (3) for transmitting microwaves (7a) and means (3) for receiving microwaves (7b), the method further comprising:
delivering at least a part of the transmitted microwaves (7a) into the medium (10),
measuring with the means (3) for receiving microwaves (7b) at least a part of the microwaves (7b) reflected in the medium (10),
determining the parameters (S2) on the basis of the transmitted and received microwaves.

7. Method according to claim 6, including tuning frequency or wavelength of the microwaves (7a) to be transmitted in accordance with characteristics of the parameters (S2) to be determined.

8. Method according to claim 6, wherein the means (3) for transmitting and receiving microwaves (7a, 7b) generate pulses of a duration between 83 and 133.3 ps.

9. Method according to claim 6, including determining glucose as parameter (S2) according to concentration in the blood.

10. Method according to claim 1, including establishing a position of a measurement path (100) in the medium (10) with the aid of the means (2) for transmitting coherent light waves (6) and the means (4) for receiving light waves (8) and wherein the determination of the parameters (S1, S2) is limited to the measurement path

11. Method according to claim 10, including operating the means (2) for transmitting coherent light waves (6) so as to generate light waves in the infrared region.

12. Method according to claim 10, including establishing a time point of a measurement performed in the measurement path (100) on the basis of a specifiable time signal of the heart cycle.

13. An apparatus for carrying out a method for determining clinical and/or chemical parameters (S1) in a medium, the apparatus comprising: laser unit (2), a phototransistor unit (4), and a monitoring unit (1), the monitoring unit (1) being in operative connection with each of the laser unit (2) and the phototransistor unit (4).

14. Apparatus according to claim 13, further comprising a microwave unit (3) that is in operative connection with the monitoring unit (1).

15. Apparatus according to claim 14, wherein said microwave unit (3) has a sending apparatus, at least the sending apparatus of the microwave unit being supported movably in two planes.

16. Apparatus according to claim 13, wherein the phototransistor unit (4) exhibits a frequency-sensitive or wavelength-sensitive tuning mode.

17. Apparatus according to claim 16, wherein the frequency or the wavelength of the waves (8) to be detected is tunable.

18. Apparatus according to claim 13, wherein said monitoring unit establishes a time point of a measurement performed in a measurement path (100) on the basis of a specifiable time signal of the heart cycle.
